(19) United States
(12) Patent Application Publication
(10) Pub. No.: US 2025/0118955 A1
(43) Pub. Date: Apr. 10, 2025

(54) Overcurrent Limiting Unit and Detection Unit and Method for Manufacturing and Method for Operating the Same

(71) Applicants: Fraunhofer-Gesellschaft zur Förderung der angewandten Forschung e.V., München (DE); Friedrich-Alexander-Universitaet Erlangen-Nuernberg, Erlangen (DE)

(72) Inventors: Johannes GEHRING, Erlangen (DE); Raffael SCHWANNINGER, Nürnberg (DE); Bernd WUNDER, Erlangen (DE)

(21) Appl. No.: 18/905,276

(22) Filed: Oct. 3, 2024

(30) Foreign Application Priority Data
Oct. 10, 2023 (EP) 23202843.1

(51) Int. Cl. H02H 3/087; H02H 1/00

(52) U.S. Cl. CPC H02H 3/087; H02H 1/0007

(57) ABSTRACT

An overcurrent limiting and detection unit includes a ferrite core that is brought into a saturated region with respect to its magnetic conductivity by arranging at least one permanent magnet to effect magnetic non-conductivity of the ferrite core, a network coil that is wound around a part of the ferrite core and that is configured such that, during operation of the overcurrent limiting unit and detection unit, an electric network current flows through it, the at least one permanent magnet being arranged on the ferrite core such that a magnetic flux caused by the at least one permanent magnet flows against a magnetic flux caused by the network coil during operation, wherein a detection coil being galvanically isolated from the network coil, is wound around a part of the ferrite core and is configured to detect a transition from the saturated region to an unsaturated region.

### CROSS-REFERENCE TO RELATED APPLICATIONS

This application claims priority from European Patent Application No. 23202843.1, which was filed on Oct. 10, 2023, and is incorporated herein in its entirety by reference.

The present invention relates to an overcurrent limiting unit and detection unit, a method for manufacturing an overcurrent limiting unit and detection unit and a method for operating an overcurrent limiting unit and detection unit.

### BACKGROUND OF THE INVENTION

A common problem in the configuration of protection technology in direct current (DC) networks are the high short-circuit currents having a fast rise time due to the capacitive network. In order to ensure component protection, fast switching off is needed for sensitive components, especially with electronic switches. This asks for fast and robust detection methods. At the same time, the current rise can be limited by inductances, which means that the switch can switch off at lower currents, but takes longer to switch and has to convert more energy due to the additional inductively stored energy.

A similar problem is also known with AC networks.

The short-circuit behavior of DC networks is generally known [1] [2]. For optimum protection, fast-switching electronic switches are developed in particular, as described in CN 112 311 366 A. Various direct and indirect methods of current measurement are used for this purpose [3]. In particular, methods without or with only minor intervention are advantageous, as invasive measurement methods typically introduce additional losses. However, non-invasive measurements usually have the problem of a large delay due to the needed interference immunity.

Limiting the rate of rise of short-circuit currents is rarely used in low-voltage networks due to the additional inductance in fast electronic switches. In the high-voltage range, superconducting current limiters are available for such applications [4], but the same cannot be applied to low-voltage due to the enormous effort for maintaining superconductivity. Here, the inductance is very low in normal operation and only reaches a high value and thus current limitation at high fault currents. In the low-voltage range, an application with permanent magnets that pre-saturate the core material would be suitable. First concepts in this regard are already available (see [5] or CN 113 872 170 A).

CN 113 872 170 A discloses a DC fault current limiter technology with a magnetic saturation iron core, in particular a DC fault current limiter with a magnetic saturation iron core capable of performing secondary active current limiting, and a current limiting method. The current limiter includes: an iron core, two DC main branch windings, two coupling branch windings, a coupling branch and two permanent magnets. The iron core is square and consists of a left iron core column, a right iron core column, an upper cross yoke and a lower cross yoke. The upper cross yoke and the lower cross yoke are located at the upper end and the lower end and the permanent magnets are each embedded in the middle of the upper cross yoke and the lower cross yoke. The two DC main branch windings are wound on the left and right iron core columns, respectively, and connected in series with a DC network, and the two coupling branch windings are wound on the outer sides of the two DC branches. The main branch windings are tightly coupled and connected to the coupling branch; and the coupling branch is formed by a parallel connection of n sub-modules. The second winding in CN 113 872 170 A is used to actively limit the current. In CN 113 872 170 A, energy is transferred from the network to the secondary coil and stored there in the circuit or converted into heat.

Concepts that combine detection and current limitation are only possible with additional wiring blocks [5].

### SUMMARY

According to an embodiment, an overcurrent limiting unit and detection unit may have: a ferrite core that is brought into a saturated region with regard to its magnetic conductivity by arranging at least one permanent magnet to effect magnetic non-conductivity of the ferrite core, a network coil that is wound around a part of the ferrite core and that is configured such that, during operation of the overcurrent limiting unit and detection unit, an electric network current I_{network} flows through the same, the at least one permanent magnet being arranged on the ferrite core such that a magnetic flux caused by the at least one permanent magnet flows against a magnetic flux caused by the network coil during the operation of the overcurrent limiting unit and detection unit, wherein further a detection coil, which is galvanically isolated from the network coil, is wound around a part of the ferrite core and is configured to detect a transition from the saturated region of the ferrite core to an unsaturated region of the ferrite core by detecting a detection voltage at the detection coil during a fault operation of the overcurrent limiting unit and detection unit, wherein the overcurrent limiting unit and detection unit is configured to control a circuit breaker upon detection of the detection voltage to effect switching off of the electric network current I_{network} through the network coil.

According to another embodiment, a method for manufacturing an overcurrent limiting and detection unit may have the steps of: providing a ferrite core, arranging at least one permanent magnet on the ferrite core to cause the ferrite core to be brought into a saturated region with respect to its magnetic conductivity to effect magnetic non-conductivity of the ferrite core, arranging a network coil around a part of the ferrite core, wherein the network coil is configured such that an electric network current I_{network} flows through the same during operation of the overcurrent limiting unit and detection unit, arranging the at least one permanent magnet on the ferrite core such that a magnetic flux caused by the at least one permanent magnet flows against a magnetic flux caused by the network coil during the fault operation of the overcurrent limiting unit and detection unit, arranging a detection coil around a part of the ferrite core to cause a transition from the saturated region of the ferrite core to an unsaturated region of the ferrite core to be detected by detecting a detection voltage at the detection coil during the fault operation of the overcurrent limiting unit and detection unit, wherein arranging the detection coil takes place galvanically isolated from the network coil, and coupling a circuit breaker to the overcurrent limiting unit and detection unit, wherein the overcurrent limiting unit and detection unit is configured to control the circuit breaker upon detection of the detection voltage to effect switching off of the electric network current I_{network} through the network coil.

According to another embodiment, a method for operating an inventive overcurrent limiting and detection unit may have the steps of: operating the network coil during an operation of the overcurrent limiting and detection unit with electric current; detecting a detection voltage at the detection coil during a fault operation and subsequently controlling a circuit breaker by the overcurrent limiting unit and detection unit upon detection of the detection voltage to effect switching off of the electric network current I_{network} through the network coil.

As suggested, the overcurrent limiting unit and detection unit includes a ferrite core that is brought into a saturated region with regard to its magnetic conductivity by arranging at least one permanent magnet to effect magnetic non-conductivity of the ferrite core, a network coil that is wound around a part of the ferrite core and that is configured such that, during operation of the overcurrent limiting unit and detection unit, an electric network current I_{network} flows through the same, the at least one permanent magnet being arranged on the ferrite core such that a magnetic flux caused by the at least one permanent magnet flows against a magnetic flux caused by the network coil during the operation of the overcurrent limiting unit and detection unit, wherein further a detection coil, which is galvanically isolated from the network coil, is wound around a part of the ferrite core, and is configured to detect a transition from the saturated region of the ferrite core to an unsaturated region of the ferrite core by detecting a detection voltage at the detection coil during a fault operation of the overcurrent limiting unit and detection unit, wherein the overcurrent limiting unit and detection unit is configured to control a circuit breaker upon detection of the detection voltage to effect switching off of the electric network current I_{network} through the network coil. Typical permanent magnets cannot saturate iron cores, but ferrite cores. In the present case, the transition from a saturated region of the ferrite core to an unsaturated region of the ferrite core is detected.

The present invention describes a structure of an overcurrent limiting unit and detection unit by which a current rise can be limited and at the same time, in particular automatically, a non-invasive detection of the overcurrent is possible. The ferrite core is saturated by one or more permanent magnets, i.e. its magnetic conductivity is brought into a saturated region. The permanent magnet is oriented such that the magnetic flux caused by the permanent magnet flows opposite to the one caused by the current to be limited in the I_{network}. The permanent magnet can be configured such that the ferrite core is still saturated at nominal current. If the current strength is drastically increased, as happens in a fault operation, such as a failure, the flux density falls below the saturation limit and a strong change in inductance can be detected or measured in the network. The transition out of the saturated region can be detected by detection windings of the detection coil on the ferrite core. The coupling of the network coil with the detection coil by means of the ferrite core, which increases significantly during the transition from the saturated region, depends on the rate of current rise influenced by the inductance, whereby a voltage at the detection coil can be measured. By means of the detection coil, a fault operation, such as a failure, can be detected in situ and without time delay by measuring the detection voltage.

Here, the term “galvanically isolated” means that the network coil and the detection coil do not have any direct electrically conductive connection to each other. The network coil is connected to the network, while the detection coil is isolated from the network. In technical terms, the detection coil is “galvanically isolated” from the network coil.

The feature according to which “the overcurrent limiting unit and detection unit is configured to control a circuit breaker upon detection of the detection voltage to effect switching off of the electric network current I_{network} through the network coil” means here that the circuit breaker is controlled immediately, i.e. automatically, at the same time as the detection voltage is measured, in particular non-invasively. The circuit breaker is controlled within a few nanoseconds of the detection of the detection voltage. When the circuit breaker is controlled depends on a propagation delay of an external circuit in which the circuit breaker or the overcurrent limiting unit and detection unit is installed.

A further aspect of the present invention relates to a method for manufacturing an overcurrent limiting unit and detection unit, including providing a ferrite core, arranging at least one permanent magnet on the ferrite core to cause the ferrite core to be brought into a saturated region with respect to its magnetic conductivity to effect magnetic non-conductivity of the ferrite core, arranging a network coil around a part of the ferrite core, wherein the network coil is configured such that an electric network current I_{network} flows through the same during operation of the overcurrent limiting unit and detection unit, arranging the at least one permanent magnet on the ferrite core such that a magnetic flux caused by the at least one permanent magnet flows against a magnetic flux caused by the network coil during the fault operation of the overcurrent limiting unit and detection unit, arranging a detection coil around a part of the ferrite core to cause a transition from the saturated region of the ferrite core to an unsaturated region of the ferrite core to be detected by detecting a detection voltage at the detection coil during the fault operation of the overcurrent limiting unit and detection unit, wherein arranging the detection coil takes place galvanically isolated from the network coil, and coupling a circuit breaker to the overcurrent limiting unit and detection unit, wherein the overcurrent limiting unit and detection unit is configured to control the circuit breaker upon detection of the detection voltage to effect switching off of the electric network current I_{network} through the network coil. The suggested method for manufacturing an overcurrent limiting unit and detection unit describes a method for manufacturing the above-described overcurrent limiting unit and detection unit.

Another aspect of the present invention relates to a method for operating an overcurrent limiting unit and detection unit as described herein. The method includes operating the network coil during operation of the overcurrent limiting unit and detection unit with electric current; detecting a detection voltage at the detection coil during a fault operation and subsequently controlling a circuit breaker by the overcurrent limiting unit and detection unit upon detection of the detection voltage to effect switching off of the electric network current I_{network} through the network coil. Operation includes operating the overcurrent limiting unit and detection unit under normal, typical conditions. During operation, no detection voltage is detected. Only when fault operation occurs, the detection coil measures a detection voltage. Thus, the fault operation indicates a failure.

It is understood that individual aspects described with respect to the overcurrent limiting unit and detection unit 100 can also be implemented as a method step for operating or manufacturing the overcurrent limiting unit and detection unit. In order to avoid redundancies, the advantages and understanding of individual terms as described with respect to the overcurrent limiting unit and detection unit will not be repeated. It is understood that the details as described with respect to the overcurrent limiting unit and detection unit are also transferable to the methods. Possible details of the overcurrent limiting and detection unit and the methods are discussed in the following description of the figures. Further details are discussed in the following description of the figures.

### BRIEF DESCRIPTION OF THE DRAWINGS

Embodiments of the present invention will be detailed subsequently referring to the appended drawings, in which:

FIG. 1 is a schematic structure of the overcurrent limiting and detection unit;

FIG. 2 is a typical course of the inductance and the detection voltage in relation to the applied network current;

FIG. 3 is another schematic structure of the overcurrent limiting unit and detection unit;

FIG. 4 is another schematic structure of the overcurrent limiting unit and detection unit;

FIG. 5 is a flowchart of a method for manufacturing an overcurrent limiting and detection unit;

FIG. 6 is a flowchart of a method for operating an overcurrent limiting unit and detection unit, and

FIG. 7 is a further improved schematic structure of the overcurrent limiting unit and detection unit.

### DETAILED DESCRIPTION OF THE INVENTION

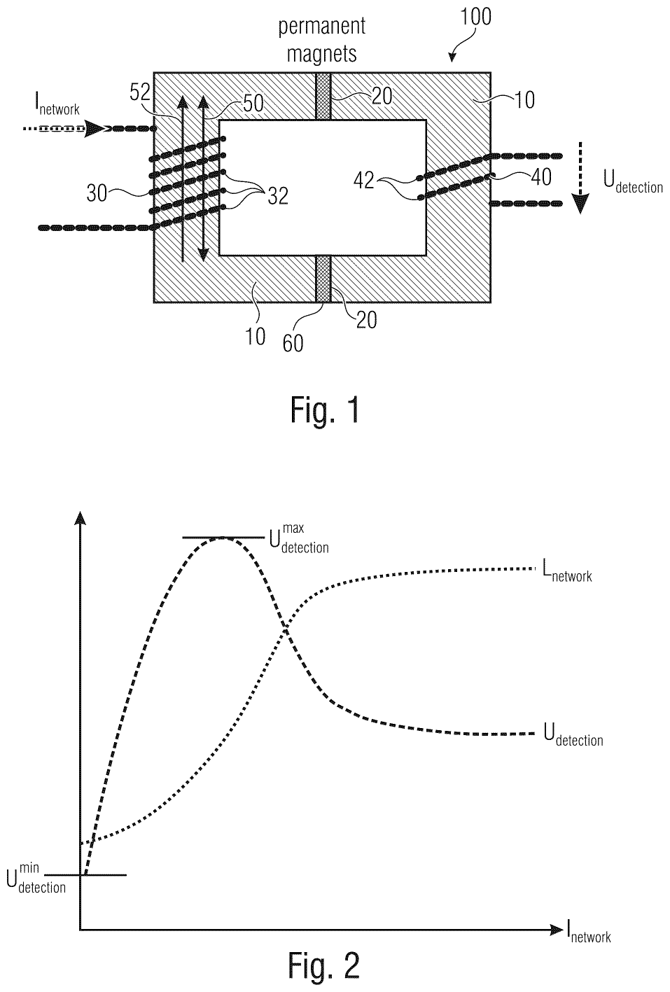

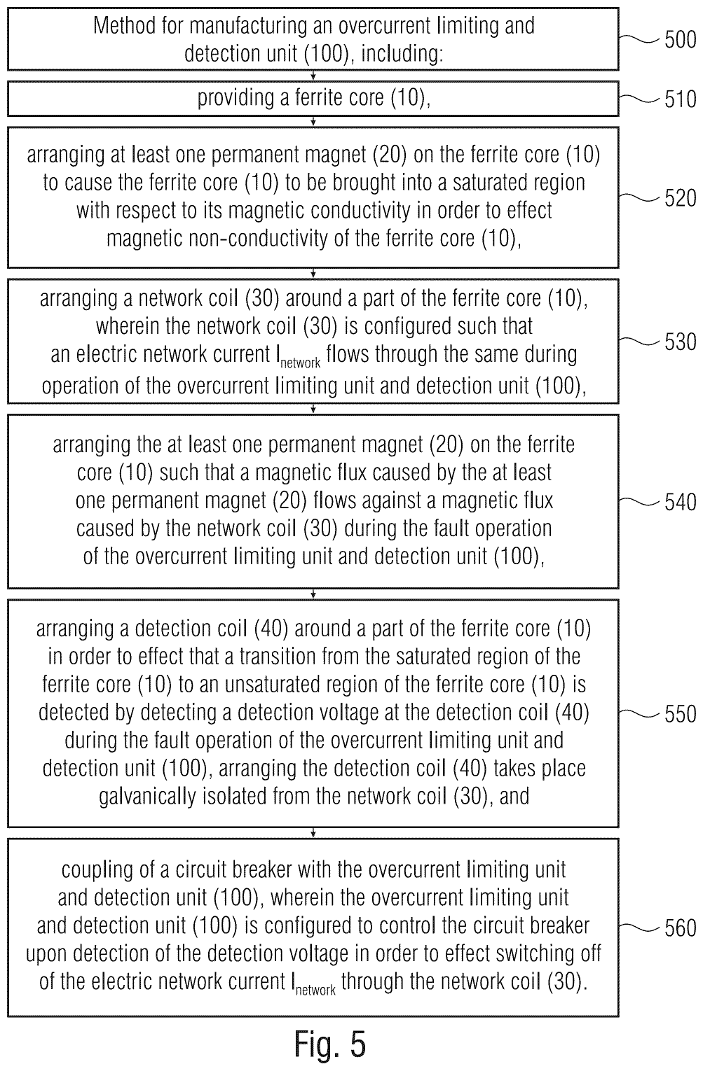

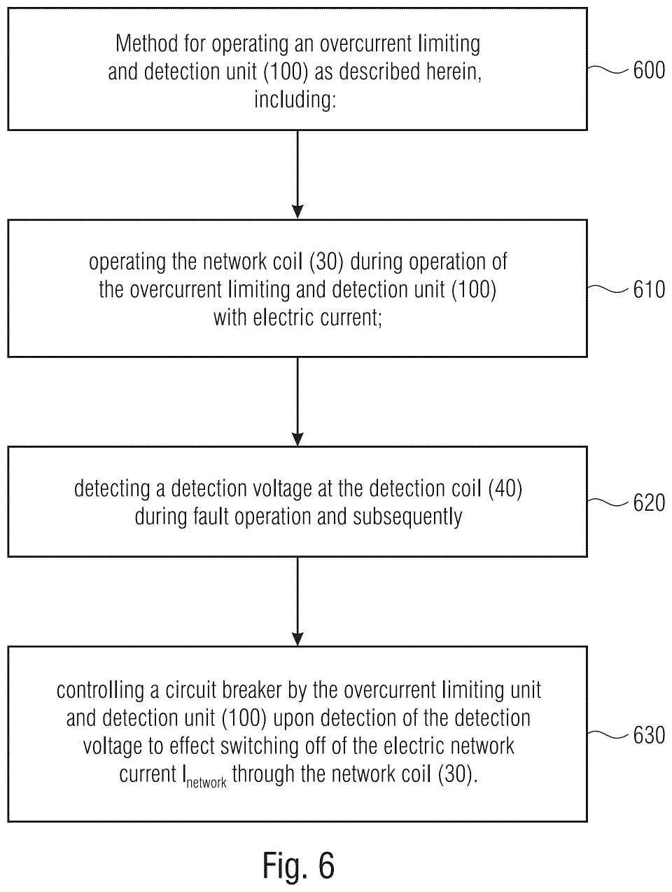

Individual aspects of the invention described herein are described below in FIGS. 1 to 6. In the present application, identical reference numbers refer to identical or equal elements, wherein not all reference numbers need to be indicated again in all drawings if they are repeated. FIGS. 1, 3 and 4 show various embodiments of the suggested overcurrent limiting unit and detection unit 100. FIG. 2 shows a typical course of a measured inductance L_{network} and a measured detection voltage U_{detection} of the suggested overcurrent limiting unit and detection unit 100. FIG. 5 shows a flowchart of a method for manufacturing an overcurrent limiting unit and detection unit 100. FIG. 6 shows a flowchart of a method for operating an overcurrent limiting unit and detection unit 100.

FIG. 1 shows a schematic structure of the suggested overcurrent limiting unit and detection unit 100. The overcurrent limiting unit and detection unit 100 includes a ferrite core 10, which is brought into a saturated region with respect to its magnetic conductivity by arranging at least one permanent magnet 20 to effect a magnetic non-conductivity of the ferrite core 10. In addition, the overcurrent limiting unit and detection unit 100 includes a network coil 30 which is wound around a part of the ferrite core 10 and which is configured such that an electric network current I_{network} flows through the same during operation of the overcurrent limiting unit and detection unit 100. The at least one permanent magnet 20 is arranged on the ferrite core such that a magnetic flux caused by the at least one permanent magnet 20 flows against a magnetic flux caused by the network coil 30 during operation of the overcurrent limiting unit and detection unit 100. Further, a detection coil 40, which is galvanically isolated from the network coil 30, is wound around a part of the ferrite core 10 and is configured to detect a transition from the saturated region of the ferrite core 10 to an unsaturated region of the ferrite core 10 during a fault operation of the overcurrent limiting unit and detection unit 100 by detecting a detection voltage at the detection coil 40. The overcurrent limiting and detection unit 100 is configured to control a circuit breaker upon detection of the detection voltage to effect switching off of the electric network current I_{network} through the network coil 30.

With the described overcurrent limiting and detection unit 100, a current rise can be limited and at the same time, in particular automatically, non-invasive detection of the overcurrent can take place. The ferrite core 10 is brought into saturation by one or more permanent magnets 20, i.e. is brought into a saturated region with respect to its magnetic conductivity. The permanent magnet 20 is oriented such that the magnetic flux 50 caused by the permanent magnet 20 flows opposite to the magnetic flux 52 generated by the current in the network I_{network} to be limited. If the current strength is drastically increased, as happens in a fault operation, such as in the event of a failure, the flux density falls below the saturation limit and a strong change of the inductance L_{network} can be detected or measured in the network. FIG. 2 shows a typical course of the inductance L_{network} in the voltage network and the measured detection voltage U_{detection} with respect to a network current I_{network} during operation, in which the fault operation is detected. The transition out of the saturated region can be detected by detection windings 42 of the detection coil on the ferrite core 10. The significantly increasing coupling between the two coils by means of the ferrite core 10 is dependent on the rate of current rise influenced by the inductance and a voltage at the detection coil 40 becomes measurable. By means of the detection coil 40, a fault operation, such as a failure, can be detected in situ and without time delay by measuring the detection voltage.

Here, the term “galvanically isolated” means that the network coil and the detection coil do not have any direct electrically conductive connection to each other. The network coil is connected to the network, while the detection coil is isolated from the network. In technical terms, the detection coil is “galvanically isolated” from the network coil. The detection coil 40 and the network coil 30 are merely coupled via the ferrite core 10, so that there is no electrical conductivity via a direct connection between the coils 30, 40.

The feature according to which “the overcurrent limiting unit and detection unit is configured to control a circuit breaker upon detection of the detection voltage to effect switching off of the electric network current I_{network} through the network coil” means here that the circuit breaker is controlled immediately, i.e. automatically, at the same time, in particular within a few nanoseconds, with the, in particular non-invasive, measurement of the detection voltage. Controlling the circuit breaker takes place within a few nanoseconds after detecting the detection voltage. When the circuit breaker is controlled depends on the propagation delay of the circuit in which the circuit breaker or the overcurrent limiting unit and detection unit is installed. The detection unit of the overcurrent limiting unit and detection unit 100 operates non-invasively, i.e. without loss. In addition, the overcurrent limiting unit and detection unit 100 makes it possible to limit or switch off the network current in fault operation without a time delay by controlling a switch. In other words, the detected detection voltage U_{detection} can be used to trigger an upstream circuit breaker.

A measurement limit of the detection unit is set so that the detection unit provides a signal (depending on the detected detection voltage U_{detection}) that the circuit breaker uses as trigger signal. Detecting the detection voltage is the operation that also provides the trigger signal. Depending on the evaluation in the switch, the circuit breaker should then be able to trigger within nanoseconds.

The suggested overcurrent limiting unit and detection unit 100 does not need any additional wiring block for detecting the fault operation, since the fault operation is considered to be detected when the detection voltage U_{detection} is detected by the detection coil 40.

FIG. 2 shows a typical course of the inductance L_{network} in the voltage network and the measured detection voltage U_{detection} with respect to a network current I_{network} during operation in which fault operation is detected. FIG. 2 shows that with an increasing current rise (plotted on the x-axis), as happens in fault operation such as in the event of a failure, the magnetic flux density 52 falls below the saturation limit of the magnetic flux density 52, as a result of which a strong change of inductance L_{network} can be detected or measured in the network. FIG. 2 shows that the measured inductance L_{network} rises steadily in the event of a failure until a plateau is reached.

The measured detection voltage U_{detection}, on the other hand, initially increases steadily until it reaches a maximum and then decreases again until the detection voltage U_{detection} also reaches a plateau. With increasing network current I_{network}, both the measured detection voltage U_{detection} and the measured inductance L_{network} converge towards a limiting value, which is here referred to as a plateau. FIG. 2 also shows that the overcurrent limiting and detection unit 100 is configured to detect a minimum detection voltage U_{detection, min}, wherein the minimum detection voltage U_{detection, min} triggers control of the circuit breaker. The amount of the detection voltage can be set based on the number of windings 42 of the detection coil 40. As the detection voltage is galvanically isolated, it can be used directly to control the circuit breaker.

The at least one permanent magnet 20 is configured such that the ferrite core 10 is in the saturated region at a nominal current Iₙₒₘᵢₙₐₗ of a current-voltage network to which the overcurrent limiting unit and detection unit (100) can be connected. The suggested overcurrent limiting unit and detection unit 100 can be used in DC voltage networks or also in AC voltage networks, in particular to protect other components in the current-voltage network in the event of a fault operation.

A ratio of a number of windings 32 of the network coil 30 to a number of windings 42 of the detection coil 40 determines a maximum detection voltage U_{detection, max}. In other words, the number of windings of the limiting side (number of windings 32 of the network coil 30) sets the inductance and the detection side sets the detection voltage U_{detection} according to the law of induction due to changing flux density:

$$n = \frac{{U}_{detection , max}}{{U}_{network , max}} ,$$

wherein n is a ratio of the number of windings, U_{detection, max} is a maximum allowable detection voltage and U_{network, max} is the maximum network voltage. The number of windings of the network coil 30 determines the current rise in the event of a fault, such as a failure, and the ratio n of the number of windings determines the maximum detection voltage U_{detection max}. The ratio n of the number of windings has to be set so that an evaluation circuit can still detect the signal at minimum network voltage. Typically, the detection side has a voltage of 3-5 V. The network side can either be a protective extra-low voltage network with 24 V, for example, or a low-voltage network with up to 1500 V or even a medium-voltage network in the 10 kV range. Thus, the ratio has to be adapted to the application. A minimum detection voltage U detection, min for triggering the switch is selected depending on the current-voltage network and can be defined individually for each configuration of the current-voltage network. The switch, to which the overcurrent limiting unit and detection unit 100 is coupled, i.e. directly connected or connected via at least one other component, is configured to switch when the minimum detection voltage U_{detection, min} is detected, i.e. measured.

By arranging the network coil 30 and the detection coil 40 at mutually spaced-apart positions on the ferrite core 10, the detection voltage is galvanically isolated from a network voltage. In FIG. 1, for example, the detection coil 40 and the network coil 30 are arranged opposite each other on two opposing U cores, with two permanent magnets 20 arranged in the areas where the two opposing U cores are adjacent to each other.

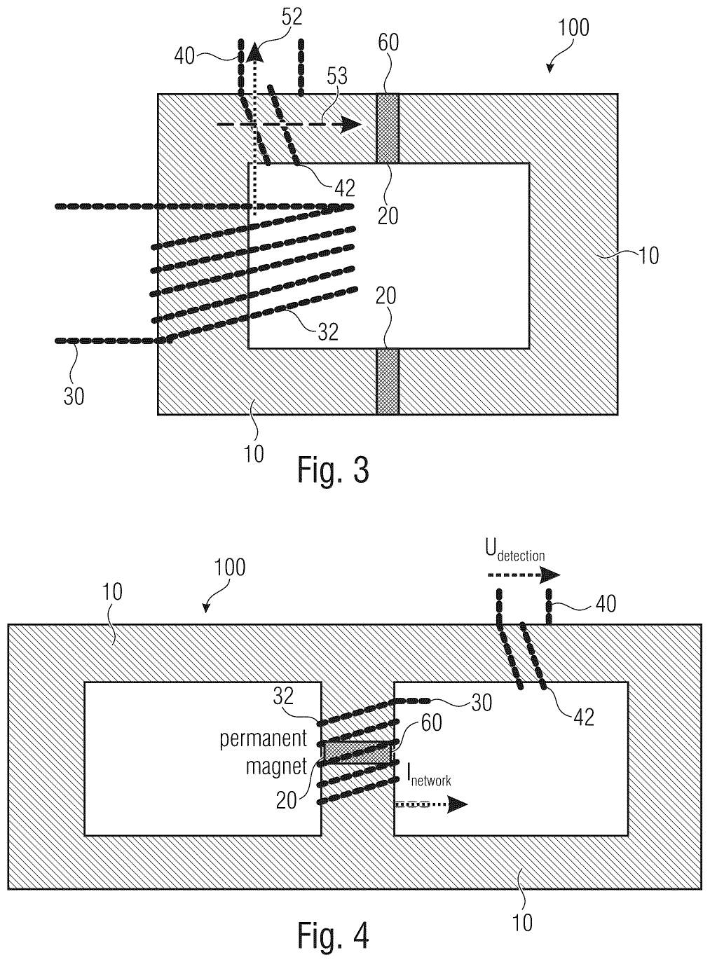

The network coil 30 and the detection coil 40 are arranged at two positions of the ferrite core 10, so that when one axis is arranged through the detection coil 40 and one axis through the network coil 30, the two axes have an intersection angle. An arrangement of the coils rotated by 90°, for example, maximizes the change in the magnetic flux density in the detection winding, i.e. in the windings 42 of the detection coil 40, between the saturated and non-saturated region. In the saturated region, however, the coupling is minimal. An arrangement rotated by 90 between detection coil 40 and network coil 30 can be seen in FIGS. 3 and 4, for example. In order to achieve the lowest possible coupling of the windings 42 of the detection coil 40 in the saturation region, the position of the detection winding can be adapted as shown, for example, in FIGS. 3 and 4.

FIG. 3 shows an improved structure of the overcurrent limiting and detection unit 100 having two U-shaped ferrite cores 10 during operation or during fault operation. The arrow 52 shows the magnetic flux when the ferrite core 10 is saturated during (normal) operation, the arrow 53 shows the magnetic flux when the core material of the ferrite core 10 is unsaturated during fault operation. It can be seen that hardly any magnetic flux flows through the windings 42 of the detection coil 40 when the core 10 is saturated. As soon as the core 10 is desaturated, the core 10 conducts the magnetic flux (arrow 53), which then flows through the windings 42 of the detection coil 40 to the maximum.

FIG. 4 shows a further improved structure of the overcurrent limiting and detection unit 100 having two E cores, which form the ferrite core 10. To achieve the greatest possible change in inductance, a structure having E cores and a small air gap 60 is particularly suitable, as shown in FIG. 4. In this context, small means that the air gap 60 is not larger than the permanent magnet 20. The air gap 60 is in the range of a few mm.

The coupling in the saturated state, as with an arrangement of the detection coil 40 and the network coil 30 as shown in FIG. 1, is significantly greater than with an arrangement of the detection coil 40 and the network coil as shown in FIGS. 3 and 4. In this case, however, the coupling is still low compared to the unsaturated state of the ferrite core 10.

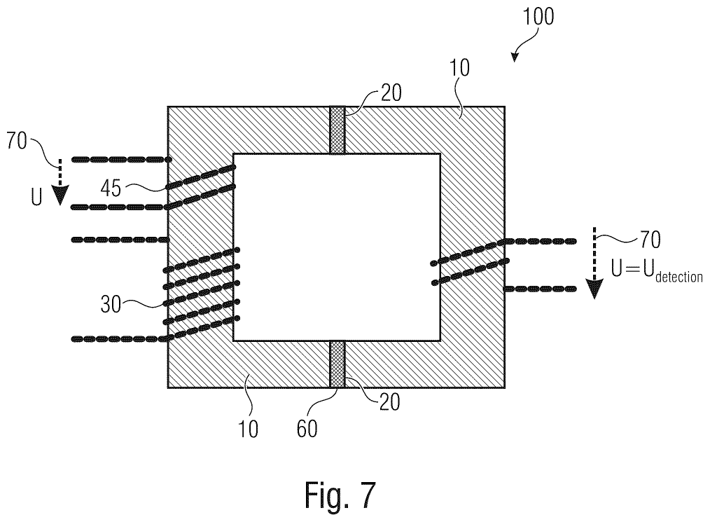

FIG. 7 shows a further improved structure of the overcurrent limiting unit and detection unit 100 with an additional coil 45. In accordance with an embodiment of FIG. 7, the overcurrent limiting unit and detection unit 100 comprises an additional coil 45, which is wound around a part of the ferrite core 10 and which is arranged relative to the network coil 30 such that the additional coil 45 and the network coil 30 have a coupling that is independent of the saturation of the ferrite core 10. To improve detection, the additional coil (45) is wound around the ferrite core 10. The additional coil 45 is arranged such that it has good coupling to the network coil 30. The coupling of these two coils 30, 45 is thus largely independent of the saturation of the ferrite core 10, whereas the coupling of the detection winding 40, i.e. the detection coil 40, is strongly dependent on the state of the ferrite core 10, i.e. whether the ferrite core 10 is in the saturated or unsaturated region. In any case, the voltage U can be measured at the detection coil 40 and at the additional coil 45 (see arrows 70 in FIG. 7). By evaluating the difference between the two coil voltages 70, influences of the network on the detection can be compensated for the most part, such as the dependence of the detection voltage on the network voltage or inductances in the network.

The ferrite core 10 includes at least one U core and/or at least one E core. FIGS. 1 and 3 show, for example, two U cores and FIG. 4 shows, for example, two E cores. A cuboid core having an E or U core can also be used together. The core design is not decisive for the function. There are many different core designs (RM cores, ELP cores or ETD cores), which are then selected in applications for the available installation volume. RM stands for “Rectangular Modulus”, EPL for “E Low Profile”, where E describes the shape of the core, and ETD for “Economic Transformer Design”. E and U cores are the most common shapes, but a wide variety of shapes are possible, in particular a customized core shape is also optimal for this form of detection. For example, having a customized core shape can optimize the arrangement of the detection winding 40 (detection coil 40) to the network winding 30 (network coil 30) for a minimum flux density in the detection winding 40 with a saturated core. The suggested overcurrent limiting unit and detection unit 100 can be configured with any known core design. Two core halves are used between which the permanent magnets 20 are arranged and a detection coil 40 is attached somewhere on one of the ferrite cores 10.

The ferrite core 10 can comprise an air gap 60, or the ferrite core 10 can comprise no air gap 60. In FIGS. 1, 3 and 4, for example, the opposing ferrite cores 10 are separated from each other by an air gap 60, wherein the permanent magnets 20 are arranged above the air gap 60. In an arrangement without an air gap 60, the at least one permanent magnet 20 would be positioned outside the at least one ferrite core 10 (not shown).

The at least one permanent magnet 20 can, for example, be configured as a single permanent magnet 20 having a thickness of 1 mm or as two permanent magnets 20 each having a thickness of 500 μm. The permanent magnet 20 is selected so that the flux density in the ferrite core 10 matches the configuration of the overcurrent limiting and detection unit 100. More than two permanent magnets 20 can also be used, wherein the number of permanent magnets used is limited by the fact that the magnet cannot be formed thinner than a minimum thickness for manufacturing reasons. Typical thicknesses of the permanent magnets 20 are between 100 μm and 1 mm. However, there can also be arrangements of the overcurrent limiting and detection unit 100 having at least one permanent magnet 20 with a thickness of 2 mm or greater. If the ferrite core 10 is configured to be structurally larger, in particular if more electric current is to flow through the ferrite core 10, then the area of the air gap also becomes larger. If, on the other hand, the electric current is to be smaller, i.e. a smaller ferrite core 10 is selected, then the magnet 20 is also configured smaller. In other words, the size dimensions of the at least one permanent magnet 20 is to be selected depending on the size dimensions of the ferrite core 10.

A further aspect of the present invention relates to a method 500 for manufacturing an overcurrent limiting and detection unit 100. The method 500 includes, in step 510, providing a ferrite core 10, in step 520, arranging at least one permanent magnet 20 on the ferrite core 10 to cause the ferrite core 10 to be brought into a saturated region with respect to its magnetic conductivity to cause the ferrite core 10 to be magnetically non-conductive. In step 530, the method 500 includes arranging a network coil 30 around a part of the ferrite core 10, wherein the network coil 30 is configured such that an electric network current I_{network} flows through the same during an operation of the overcurrent limiting and detection unit 100. In step 540, the method 500 includes arranging the at least one permanent magnet 20 on the ferrite core 10 such that a magnetic flux caused by the at least one permanent magnet 20 flows against a magnetic flux caused by the network coil 30 during operation of the overcurrent limiting unit and detection unit 100. Thus, the magnetic fluxes flow parallel to each other and against each other. In step 550, the method 500 includes arranging a detection coil 40 around a part of the ferrite core 10 to cause the overcurrent limiting unit and detection unit 100 to detect a transition from the saturated region of the ferrite core 10 to an unsaturated region of the ferrite core 10 by detecting a detection voltage at the detection coil 40 during a fault operation, wherein arranging the detection coil (40) takes place galvanically isolated from the network coil (30). In step 560, the method 500 includes coupling a circuit breaker to the overcurrent limiting unit and detection unit 100, wherein the overcurrent limiting unit and detection unit 100 is configured to control the circuit breaker upon detection of the detection voltage to effect switching off of the electric network current I_{network} through the network coil 30. Steps 520 to 550 can be interchanged as desired as long as an overcurrent limiting unit and detection unit 100 results, as shown in FIG. 1, 3 or 4, for example. The method 500 can also include providing several ferrite core halves, the ferrite core halves arranged together forming the ferrite core 10. Here, steps 520 to 550 can first be performed on the ferrite core halves and then step 510 can be performed by arranging the ferrite core halves opposite each other, as shown in FIGS. 1, 3 and 4.

A further aspect of the present invention relates to a method 600 of operating an overcurrent limiting unit and detection unit 100 as described herein. In a step 610, the method 600 includes operating the network coil 30 during an operation of the overcurrent limiting unit and detection unit 100 with electric current. In a step 620, the method 600 includes detecting a detection voltage at the detection coil 40 during a fault operation. In a subsequent step 630, the method 600 includes controlling a circuit breaker by the overcurrent limiting unit and detection unit 100 upon detection of the detection voltage to effect switching off of the electric network current I_{network} through the network coil (30). For controlling the circuit breaker, the overcurrent limiting unit and detection unit 100 can be coupled to a controller or configured with a controller. By detecting the detection voltage U_{detection}, the controller causes a signal to be output, which causes the circuit breaker to switch to effect switching off of the current-voltage network. In particular, a sub-network with the nominal current Iₙₒₘᵢₙₐₗ in which the failure is detected is switched off. Further switching operations can be carried out coupled therewith to isolate critical components, etc. The operation includes operating the overcurrent limiting unit and detection unit under normal, typical conditions. No detection voltage is detected during operation. Only when fault operation occurs, the detection coil measures a detection voltage. Thus, the fault operation indicates a failure.

The possibility of detection by means of the overcurrent limiting and detection unit 100 described herein achieves a galvanically isolated trigger signal of high amplitude at a defined current strength, which can be used to control triggering of a circuit breaker directly without any additional time delay. In addition, the limitation of the current rise makes it possible to set a defined maximum rate of rise, which simplifies the configuration of the switch.

Using a different detection method would lead to higher losses or longer processing times with the same interference immunity. Further, the same would not have the advantage of limiting the current rise. Alternative possibilities for limiting the current rise are possible, but this causes additional costs and installation space as an additional installation part. With the present invention, costs and installation space can be saved.

The technical field of application of the present invention are electronic switches in DC networks in the low-voltage range, although application in AC networks is basically also possible.

The term “configured for” used herein expresses that the overcurrent limiting and detection unit 100 has to be objectively suitable for the stated purpose or function. Thus, the subject-matter claim is directed to an apparatus realizing said purpose or function. The purpose and function specifications made herein define the subject matter of the claim to the effect that the overcurrent limiting unit and detection unit 100, in addition to fulfilling the further spatial and physical features, also has to be configured such that the overcurrent limiting unit and detection unit 100 is used for the purpose or fulfills the function specified in the claim.

Although some aspects have been described in the context of an apparatus or a system, it is understood that these aspects also represent a description of a corresponding method, so that a block or a device of an apparatus or a system is also to be understood as a corresponding method step or as a feature of a method step. For reasons of redundancy, a complete description of the present invention in the form of method steps is omitted.

In the preceding detailed description, various features have been grouped together in examples in part to streamline the disclosure. This type of disclosure should not be interpreted as intending that the claimed examples have more features than are explicitly stated in each claim. Rather, as the following claims reflect, subject matter may be found in fewer than all of the features of a single disclosed example. Consequently, the following claims are hereby incorporated into the detailed description, and each claim may stand as its own separate example. While each claim may stand as its own separate example, it should be noted that although dependent claims in the claims refer back to a specific combination with one or more other claims, other examples also include a combination of dependent claims with the subject matter of any other dependent claim or a combination of any feature with other dependent or independent claims. Such combinations are encompassed unless it is stated that a specific combination is not intended. It is further intended that a combination of features of a claim with any other independent claim is also encompassed, even if that claim is not directly dependent on the independent claim.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### BIBLIOGRAPHY

[1] R. Bleilevens and A. Moser, “Simplified Short Circuit Current Calculation for DC Distribution Networks based on a Superposition Approach using Approximated Current Courses,” 2020 5th IEEE Workshop on the Electronic Network (eNETWORK), 2020.
[2] D. Petropoulos, L. Mackay, L. Ramirez-Elizondo, M. Popov, and P. Bauer, “Transient analysis of DC distribution networks,” 2017 IEEE Second International Conference on DC Micronetworks (ICDCM), 2017.
[3] R. Rodrigues, Y. Du, A. Antoniazzi, and P. Cairoli, “A Review of Solid-State Circuit Breakers,” IEEE Trans. Power Electron. (IEEE Transactions on Power Electronics), 2021
[4] Z. Lin, J. Jin, Q. Yin, Y. Liu, J. Xu, and X. Zeng, “Study on Coordination of Resistive-Type Superconducting Fault Current Limiter and DC Circuit Breaker in HVDC system,” 5th Asia Conference on Power and Electrical Engineering (ACPEE), 2020.
[5] A. Hosseinzadeh and H. Heydari, “A Fast Fault Detection Method for Protection of HVDC Transmission using Voltage of The PMFCL,” 10th Iranian Conference on Renewable Energy & Distributed Generation (ICREDG), 2023.

1. An overcurrent limiting unit and detection unit comprising:
a ferrite core that is brought into a saturated region with regard to its magnetic conductivity by arranging at least one permanent magnet to effect magnetic non-conductivity of the ferrite core,
a network coil that is wound around a part of the ferrite core and that is configured such that, during operation of the overcurrent limiting unit and detection unit, an electric network current I_{network} flows through the same,
the at least one permanent magnet being arranged on the ferrite core such that a magnetic flux caused by the at least one permanent magnet flows against a magnetic flux caused by the network coil during the operation of the overcurrent limiting unit and detection unit, wherein further a detection coil, which is galvanically isolated from the network coil, is wound around a part of the ferrite core and is configured to detect a transition from the saturated region of the ferrite core to an unsaturated region of the ferrite core by detecting a detection voltage at the detection coil during a fault operation of the overcurrent limiting unit and detection unit, wherein the overcurrent limiting unit and detection unit is configured to control a circuit breaker upon detection of the detection voltage to effect switching off of the electric network current I_{network} through the network coil.

2. The overcurrent limiting unit and detection unit according to claim 1, wherein the at least one permanent magnet is configured such that the ferrite core is in the saturated region at a nominal current Iₙₒₘᵢₙₐₗ of a current-voltage network to which the overcurrent limiting unit and detection unit can be connected.

3. The overcurrent limiting unit and detection unit according to claim 1, wherein a ratio of a number of windings of the network coil to a number of windings of the detection coil determines a maximum detection voltage.

4. The overcurrent limiting unit and detection unit according to claim 1, wherein the detection voltage is galvanically isolated from a network voltage by arranging the network coil and the detection coil at mutually spaced-apart positions of the ferrite core.

5. The overcurrent limiting unit and detection unit according to claim 1, wherein the network coil and the detection coil are arranged at two positions of the ferrite core, so that when one axis is arranged through the detection coil and one axis through the network coil, the two axes comprise an intersection angle.

6. The overcurrent limiting and detection unit according to claim 1, wherein an additional coil (45) is wound around a part of the ferrite core, which is arranged relative to the network coil such that the additional coil (45) and the network coil (39) comprise a coupling that is independent of the saturation of the ferrite core.

7. The overcurrent limiting and detection unit according to claim 1, wherein the ferrite core comprises at least one U core and/or at least one E core

8. The overcurrent limiting and detection unit according to claim 1, wherein the ferrite core comprises an air gap, or wherein the ferrite core comprises no air gap.

9. A method for manufacturing an overcurrent limiting and detection unit, comprising:
providing a ferrite core,
arranging at least one permanent magnet on the ferrite core to cause the ferrite core to be brought into a saturated region with respect to its magnetic conductivity to effect magnetic non-conductivity of the ferrite core,
arranging a network coil around a part of the ferrite core, wherein the network coil is configured such that an electric network current I_{network} flows through the same during operation of the overcurrent limiting unit and detection unit,
arranging the at least one permanent magnet on the ferrite core such that a magnetic flux caused by the at least one permanent magnet flows against a magnetic flux caused by the network coil during the fault operation of the overcurrent limiting unit and detection unit,
arranging a detection coil around a part of the ferrite core to cause a transition from the saturated region of the ferrite core to an unsaturated region of the ferrite core to be detected by detecting a detection voltage at the detection coil during the fault operation of the overcurrent limiting unit and detection unit, wherein arranging the detection coil takes place galvanically isolated from the network coil, and
coupling a circuit breaker to the overcurrent limiting unit and detection unit, wherein the overcurrent limiting unit and detection unit is configured to control the circuit breaker upon detection of the detection voltage to effect switching off of the electric network current I_{network} through the network coil.

10. The method for operating an overcurrent limiting and detection unit according to claim 9, comprising:
operating the network coil during an operation of the overcurrent limiting and detection unit with electric current;
detecting a detection voltage at the detection coil during a fault operation and subsequently
controlling a circuit breaker by the overcurrent limiting unit and detection unit upon detection of the detection voltage to effect switching off of the electric network current I_{network} through the network coil.
